(19) United States
(12) Patent Application Publication
(10) Pub. No.: US 2015/0127432 A1
(43) Pub. Date: May 7, 2015

(54) Testing and Evaluating the recoverability of a Process

(71) Applicant: Bank of America Corporation, Charlotte, NC (US)

(72) Inventors: Frederick Miranda, Mumbai (IN); Kavita Dudeja Dhingra, Delhi (IN); Suvabrata Sinha, Hyderabad (IN)

(21) Appl. No.: 14/594,312

(22) Filed: Jan. 12, 2015

Related U.S. Application Data
(63) Continuation of application No. 12/651,719, filed on Jan. 4, 2010.

(51) Int. Cl. G06Q 10/06

(52) U.S. Cl. CPC G06Q 10/06395
USPC 705/7.41

(57) ABSTRACT

Aspects of this disclosure relate to a computer for determining the recoverability of a process which may include a processor and memory storing computer executable instructions that, when executed, cause the computer to determine the recoverability of a process, by receiving data relating to a contingency plan for recovering the process, receiving data relating to an organization's execution of the contingency plan during a test of the recoverability of the process, and determining the recoverability of the process based on the data by calculating a cumulative overall score for the recoverability of the process, comparing the cumulative overall score with a rating chart stored in the computer, which includes numerical ranges defining a level of assurance of the recoverability of the process, and determining the recoverability of a process based on the comparison of the cumulative overall score with the rating chart.

### CROSS REFERENCE TO RELATED APPLICATIONS

This application is a continuation of and claims priority to co-pending U.S. application Ser. No. 12/651,719, filed Jan. 4, 2010, and entitled “Testing and Evaluating the Recoverability of a Process,” which is incorporated herein by reference in its entirety.

### BACKGROUND

An organization, such as a business, can ill afford to have its operations halted for a lengthy period of time (e.g., due to circumstances, such as a natural disaster, failure of technological resources, and the like) Such a stoppage of operations may be extremely detrimental to the organization's relationships with its customers and the organization's overall competitiveness in the marketplace. Therefore, it would be would be advantageous to have a contingency plan in place that allows an organization to recover its operations quickly. Further, it would be advantageous to ensure that such a contingency plan and its execution are effective and reliable.

### SUMMARY

In light of the above, it would be beneficial to provide a system and a method that test and evaluate the recoverability of one or more of the organization's operations, or processes. Therefore, aspects of this disclosure relate to a computer for determining the recoverability of a process which may include a processor and memory storing computer executable instructions that, when executed, cause the computer to determine the recoverability of a process, by receiving data relating to a contingency plan for recovering the process, receiving data relating to an organization's execution of the contingency plan during a test of the recoverability of the process, and determining the recoverability of the process based on the data by calculating a cumulative overall score for the recoverability of the process, comparing the cumulative overall score with a rating chart stored in the computer which includes numerical ranges defining a level of assurance of the recoverability of the process, and determining the recoverability of a process based on the comparison of the cumulative overall score with the rating chart. Further, calculating the cumulative overall score may include using the electronically received data to determine a score for each of a predetermined set of parameters related to the recoverability of the process. Additionally, the computer may be configured to apply a set of predetermined rules to the scores for the parameters in order to calculate the cumulative overall score. The rating chart and the rules may be stored in the computer.

Additional aspects of the disclosure relate to a computer assisted method for determining the recoverability of a process comprising electronically receiving data relating to a contingency plan for recovering the process, electronically receiving data relating to an organization's execution of the contingency plan during a test of the recoverability of the process, and using a computer to determine the recoverability of the process based on the data by calculating a cumulative overall score for the recoverability of the process comparing the cumulative overall score with a rating chart stored the in the computer which includes numerical ranges defining a level of assurance of the recoverability of the process and determining the recoverability of a process based on the comparison of the cumulative overall score with the rating chart.

According to further aspects of the disclosure, in the computer assisted method, calculating the cumulative overall score may include using the electronically received data to determine a score for each of a predetermined set of parameters related to the contingency plan. Additionally, calculating the cumulative overall score may also include using the electronically received data to determine a score for each of a predetermined set of parameters related to the organization's execution of the contingency plan.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a diagram of a general-purpose digital computing environment in which certain aspects of the present disclosure may be implemented;

FIGS. 2A and 2B are a flowchart of an illustrative example of a method for testing and evaluating the recoverability of a process according to at least one aspect of the present disclosure;

FIG. 3 is a chart including illustrative examples of planning parameters that may be tested and evaluated during a business continuity test according to one aspect of this disclosure;

FIG. 4 is a chart including illustrative examples of execution parameters that may be tested and evaluated during a business continuity test according to one aspect of this disclosure;

FIG. 5 shows an illustrative embodiment of test assessment template which includes the parameters that may be tested and evaluated during a business continuity test according to one aspect of this disclosure;

FIG. 6 is a chart which includes illustrative examples of scores (and the different criteria associated with the scores) of each of the planning parameters to be tested and evaluated during a business continuity test according to one aspect of this disclosure;

FIG. 7 is a chart which includes illustrative examples of scores (and the different criteria associated with the scores) of each of the execution parameters to be tested and evaluated during a business continuity test according to one aspect of this disclosure;

FIG. 8 is an illustrative embodiment of a scorecard according to aspects of the disclosure;

FIG. 9 is an illustrative embodiment of a weighted scoring grid according to aspects of the disclosure; and

FIG. 10 is an illustrative embodiment of a final rating chart according to aspects of this disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

It is noted that throughout the disclosure, the term business may be used interchangeably with organization, financial institution, bank, and the like. The term business is not intended to be limiting, but rather merely describe a potential embodiment of the disclosure.

A business may have many different processes (e.g., hundreds) that relate to or make up the business's operations. For example, a business, such as a bank, may have various different processes related to: opening financial accounts, closing financial accounts, management of accounts (e.g., online management of accounts), risk management for the bank including performing various risk reviews, performing loss mitigation reviews, internal and external reporting, budgeting and forecasting, database administration and management, information technology, customer support (e.g., related to inbound phone calls for customer support via telephone, online customer support, or the like), workforce management (e.g., coordinating real-time staffing needs and changes as they occur), and the like. As will be understood from just this sampling of processes, there are numerous processes and the processes can vary dramatically depending on the business.

However, regardless of the number or type of processes, as discussed above, a stoppage of business's processes and, therefore, a stoppage of the business's operations may be detrimental. Therefore, according to aspects of this disclosure, a business may have contingency plans designed to allow the business to recover the business's processes quickly in the event of a disaster (e.g., a natural disaster, failure of technological resources, and the like) and, thereby, substantially prevent or minimize the length of time that a business's processes are halted. Hence, it is understood, that the contingency plans are designed to ensure that the processes continue functioning. In other words, the contingency plans relate to maintaining the continuity of the processes. In this way, the business operations are maintained and overall business continuity may be achieved.

According to aspects of this disclosure, such contingency plans may involve transferring, or migrating, the processes a recovery location. For example, according to aspects of this disclosure, contingency plans may involve transferring or migrating processes to other personnel at a migration site (i.e., an alternate site different from the original location where the processes are usually performed) For example, the operations may be transferred to a location of a parent company during the contingency plan. According to other aspects of this disclosure, contingency plans may involve transferring processes to other personnel at one or more alternate locations. For example, the performance of the processes may be split between personnel at more than one alternate location (i.e., split teams). According to other aspects of this disclosure, contingency plans may involve transferring the actual personnel who usually work on the processes to an alternate location (e.g., a predetermined alternate location designed for such a contingency plan). It is noted that this type of contingency plan may be implemented for extended outages.

However, if such contingency plans are not planned and executed correctly then such contingency plans may not be effective. Hence, aspects of this disclosure are directed to systems and methods for testing and evaluating a business's contingency plan for recovering a process. Further, aspects of this disclosure are directed to systems and methods for testing and evaluating the business's ability to execute the contingency plan (e.g., testing and evaluating the process when the process is implemented according to the business's contingency plan).

The systems and methods designed for testing and evaluating the contingency plans and the processes themselves when they are run under the business's contingency plans, provide feedback to the business as to whether such contingency plans, and the processes themselves when they are run under the business's contingency plans, are effective. Hence, if the tests and evaluations indicate that a particular contingency plan and, also, its related process when implemented according the business's contingency plan, are not effective, then the business could modify the contingency plan and, also, the execution of the process when implemented according to business's contingency plan, so that the business would be prepared if a disaster did occur. Further, if the tests and evaluations indicate that the particular contingency plan and, also, its related process when implemented according the business's contingency plan are effective, then the testing and evaluation would provide assurance to the business on the preparedness of the process to handle a contingency.

As described above, a single business may have numerous varied processes. Hence, it would be advantageous to have a system and method that test and evaluate the contingency plans and, the processes themselves when implemented according to a business's contingency plan, with a consistent evaluation regardless of the particular process. Therefore, aspects of this disclosure relate to a structured approach in defining the requirements of the test, assessing the testing, and providing a standard metric for evaluating the tests conducted.

According to aspects of this disclosure, the system and method for testing and evaluating the recoverability of a process includes testing and evaluating a contingency plan and testing and evaluating the process itself when it is run under the business's contingency plan. In other words, the system and method for testing and evaluating the recoverability of a process are designed to evaluate at least two different features. First, the system and method evaluate the recovery procedures defined in contingency plan. Second, the system and method evaluate the ability of the business to execute the procedures defined in the contingency plan by evaluating the success of a test of the recoverability of the process based on the actual demonstration of the process when it is run according to the recovery procedures defined in under the contingency plan. A detailed description of these two features and other aspects of the system and method for testing and evaluating the recoverability a process are presented below.

The actual testing of the process when it is run according to the contingency plan may be referred to throughout the disclosure as a business continuity test (BCT). According to aspects of this disclosure, initially, in order to have test administrators (BCT administrators) conduct a business continuity test and, also, offer an evaluation on the recoverability of a business's process, the business may first be required to submit a business impact analysis (BIA) and a contingency plan. The BIA may include a discussion of the importance of the particular process to the business. For example, according to aspects of this disclosure, in the BIA, the process may be rated as low, medium, high, or significantly high, wherein significantly high means that the processes is extremely important to the business and the impact of having the process halted for a significant amount of time would be extremely detrimental to the business. It is noted that the importance of the process to the business as indicated by the rating may determine how often the contingency plan and the process are tested and evaluated. For example, according to aspects of this disclosure, if the process is rated as significantly high, it may be tested yearly, whereas if the process is rated as low, it may be tested only once every two years. Of course, the frequency of the test could vary as desired.

Throughout the disclosure, the contingency plan may also be referred to as a Process Level Plan (PLP). The contingency plan, or PLP, may define all aspects of the plan for recovering the particular process, including particular recovery procedures that are to be implemented in case of a disaster. During a test of the process when run under the contingency plan, the business would have to perform the recovery procedures outlined in the contingency plan. The particular aspects of the elements within the contingency plan may vary depending on the particular contingency plan and will be described in detail below.

According to aspects of this disclosure, the business continuity test may commence with a communication from the business continuity test administrators to the business itself (e.g., an email from the test administrators to the business's employee in charge of the operation of the contingency plan for the particular process) informing the business of the simulated disaster and that the contingency plan is to be put into effect. From that point on, the business would be operating according to the contingency plan in order to recover the process and ensure the continuity of the process. When the business continuity test is to be concluded, a communication from the business continuity test administrators may be sent to the business itself (e.g., an email from the test administrators to the businesses employee in charge of the operation of the contingency plan for the process) informing the business that the simulated disaster is over and the business may go back to operating normally.

According to aspects of this disclosure, after the conclusion of the business continuity test, the business would have to provide various pieces of evidence to the business continuity test administrators in order for the business continuity test administrators to evaluate the recoverability of the process. According to aspects of this disclosure, some of the evidence relates to whether particular parameters (to be discussed in detail below) were met during the time period the business continuity test was conducted (i.e., the time period between when the invocation communication was sent to the business and when the revocation communication was sent to the business during which the business was operating the process under the contingency plan).

According to aspects of the disclosure, business continuity test administrators will evaluate the evidence provided by the business in order to determine whether the business met (or failed to meet) particular objectives related to the parameters. According to aspects of the disclosure, the test administrators may define particular parameters and objectives on which the contingency plan and the recoverability of the process under the contingency plan will be judged. According to aspects of the disclosure, the test administrators may organize these parameters in a particular format. Throughout this disclosure, the format is referred to as a business continuity test assessment. According to aspects of this disclosure, the parameters set forth in the business continuity test assessment may remain the same regardless of which process is tested and evaluated. In this way, the business continuity test can provide a uniform standard for defining the requirements of the test, assessing the testing, and providing a standard metric for evaluating the tests conducted. It is noted, of course, that the test administrators may vary which of the parameters are to be included in the test assessment. It is also noted that according to other aspects of this disclosure, if desired, the parameters set forth in the business continuity test assessment may vary even from test to test.

The test administrators may correlate the evidence provided by the business with the particular parameters and objectives defined in the test assessment. Further, according to aspects of the disclosure, based on the evidence the test administrators will assign scores to the particular parameters and provide a cumulative overall score regarding both the contingency plan and the recoverability of the process under the contingency plan. Based on the cumulative overall score, the business can determine whether the contingency plan and the recoverability of the process under the contingency plan are effective and acceptable.

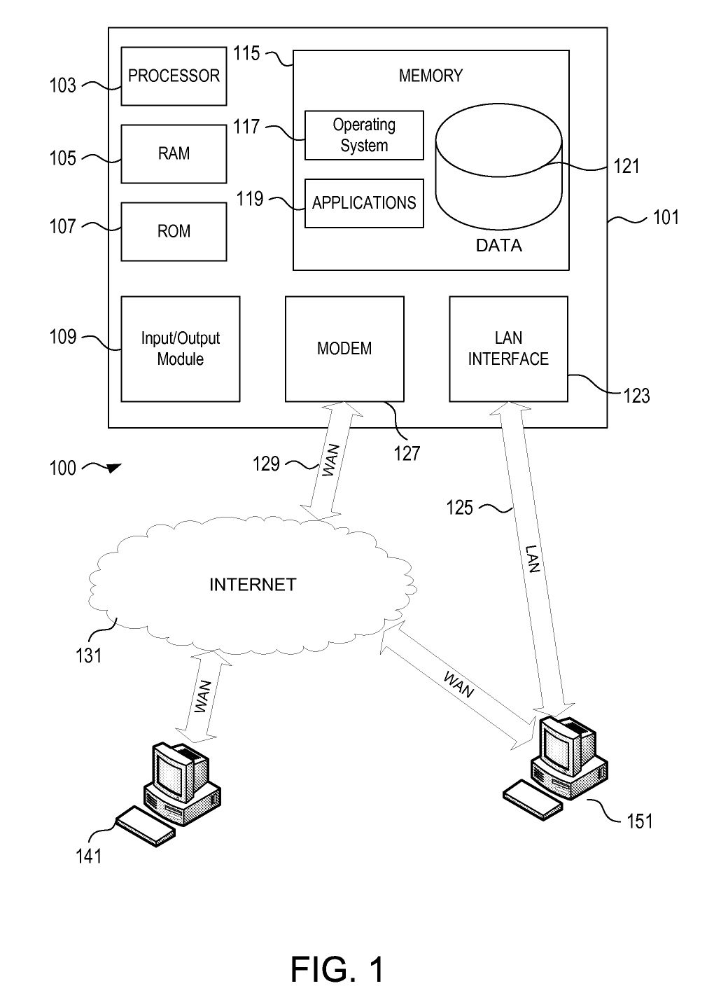

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and the like, that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

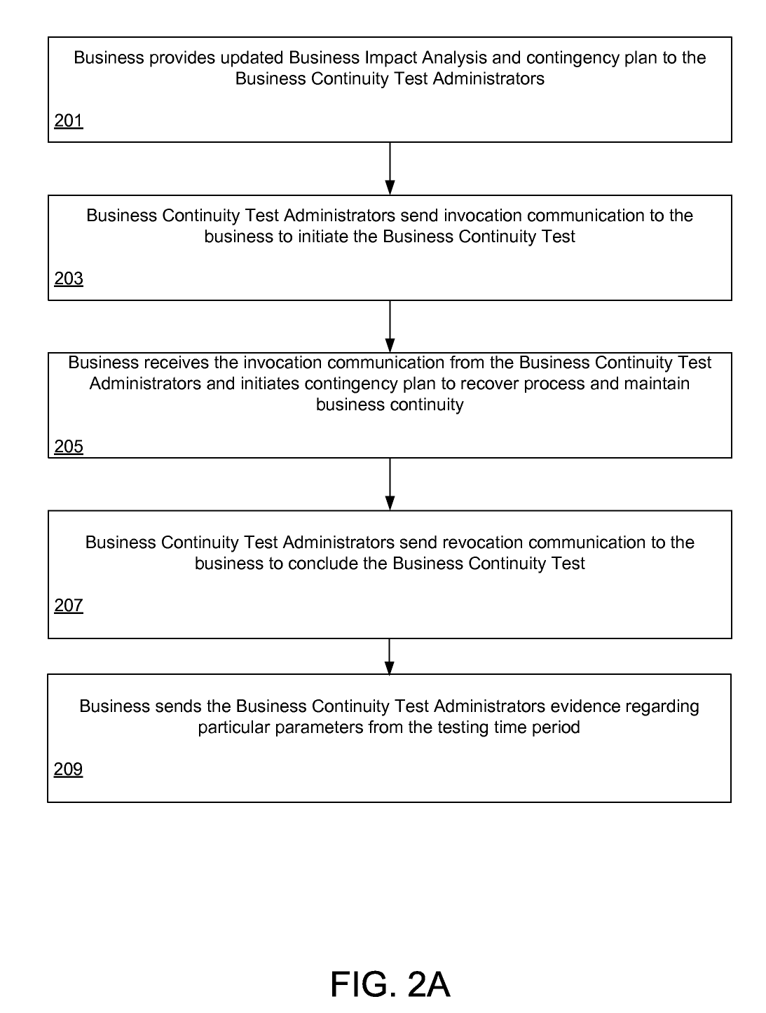

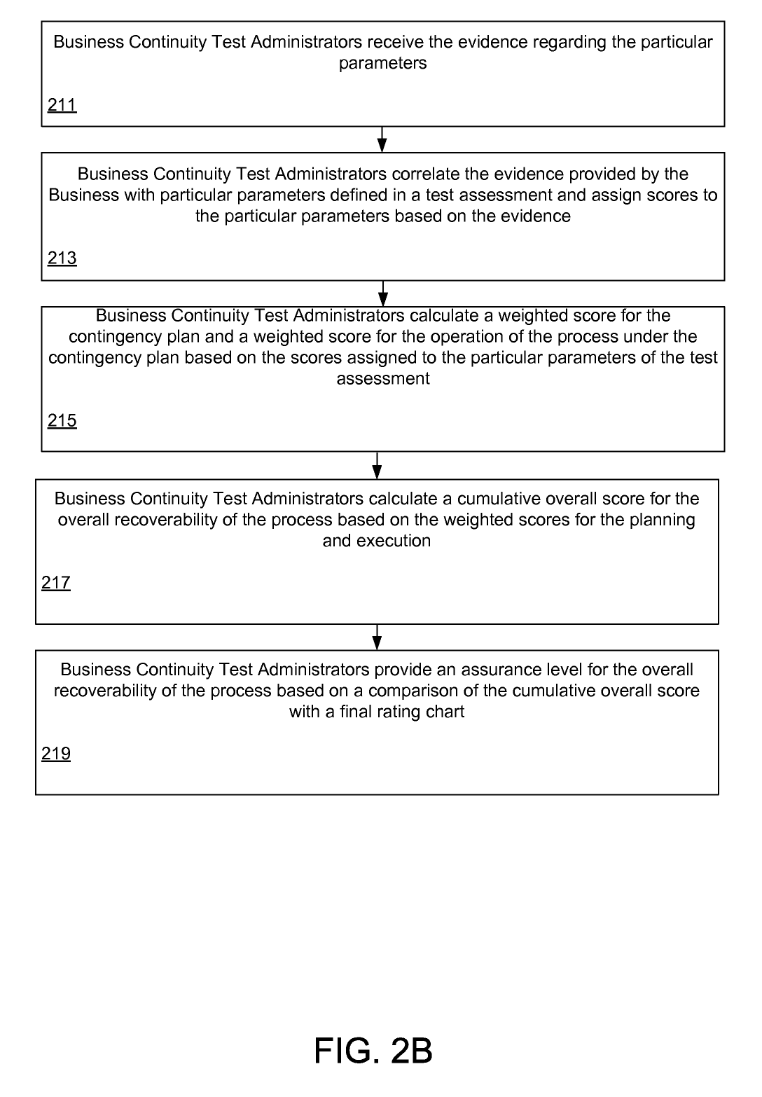

FIG. 2 illustrates a flow chart which demonstrates illustrative aspects of the system and method for determining whether the contingency plan and the recoverability of the process under the contingency plan are effective and acceptable. As seen in step 201, the business provides updated Business Impact Analysis and a contingency plan to the business continuity test administrators. In step 203, the business continuity test administrators send an invocation communication to the business to the initiate the business continuity test. In step 205, the business receives the invocation communication from the business continuity test administrators and initiates the contingency plan to recover the process and thereby, maintain business continuity. In step 207, the business continuity test administrators send a revocation communication to the business to conclude the business continuity test. In step 209, the business sends the business continuity test administrators evidence regarding particular parameters from the testing time period. In step 211, the business continuity test administrators receive the evidence regarding the particular parameters. In step 213, the business continuity test administrators correlate the evidence provided by the business with particular parameters defined in a test assessment and assign scores to the particular parameters based on the evidence. In step 215, the business continuity test administrators calculate a weighted score for the planning (i.e., the contingency plan) and a weighted score for the execution (i.e., the operation of the process under the contingency plan) based on the scores assigned to the particular parameters of the test assessment. In step 217, the business continuity test administrators calculate a cumulative overall score for the overall recoverability of the process based on the weighted scores for the planning and execution. In step 219, the business continuity test administrators provide an assurance level for the overall recoverability of the process based on a comparison of the cumulative overall score with a final rating chart.

According to aspects of this disclosure, the actual contingency plan may vary depending on the particular process for which it is designed or other factors. For example, as discussed above, according to one aspect the disclosure, a contingency plan may involve relocating business employees to an alternate location in order to recover the process. In other words, the employees who perform the process during a “business as usual” scenario would be relocated to an alternate location in order to continue performing the process. According to aspects of the disclosure, a contingency plan for such a test would need to indentify a team of employees who would be considered critical members (i.e., critical resources) required to perform the process from the alternate location. A contingency plan for such a test would need to indentify logistical information for the relocation, including: facilities at the alternate location, food and lodging at the alternate location, security at the alternate location, technological resources at the alternate location (e.g., that the required technological resources are at the alternate location and that the technological resources would be ready for use when the critical resources arrive), travel arrangements to move the critical resources to the alternate location, a time period within which the critical resources must be contacted upon the commencement of the disaster (e.g., 20 minutes), a time period within which the critical resources, must be relocated to the alternate location upon commencement of the disaster (e.g., 180 minutes), a contact list or emergency call tree for the critical resources, a list of backups for the critical resources, and the like.

According to another aspect of this disclosure, as discussed above, a contingency plan may involve transferring operations (i.e., transferring the process) to another group of the business's employees who are located at alternate location in order to recover the process. In other words, a different group of employees (who are located at a different location than the employees at the original location and who perform the process during a “business as usual” scenario) would now perform the process under the contingency plan to ensure the continuity of the process during the disaster. According to aspects of the disclosure, a contingency plan for such a test would need to indentify a team of employees at the alternate location who would be considered critical members (i.e., critical resources) required to perform the process during the time that the original location is down. A contingency plan for such a test would need to indentify other information, such as: a time period within which the critical resources must be contacted upon the commencement of the disaster (e.g., 20 minutes), a time period within which the critical resources, must be performing the transferred processes (e.g., 180 minutes), a contact list or emergency call tree for the critical resources, a list of backups for the critical resources, and the like.

According to another aspect of this disclosure, as discussed above, a contingency plan may involve transferring operations to several other groups of the business's employees who are located at several alternate locations in order to recover the process. In other words, the process is split between several different groups of employees at several respective different locations (as compared with the employees at the original location and who perform the process during a “business as usual” scenario) and, further, the several different groups of employees at several respective different locations (i.e., the split teams) would now perform the process under the contingency plan to ensure the continuity of the process during the disaster. According to aspects of the disclosure, the split teams may perform the process simultaneously or in shifts (e.g., one location perform the process for a first shift while a second location performs the process for a second shift). According to aspects of the disclosure, such a contingency plan would need to indentify a team of employees at each the several alternate locations who would be considered critical members (i.e., critical resources) required to perform the process during the time that the original location is down. A contingency plan for such a test would need to indentify other information, such as: the coordination of which of the alternate locations would be responsible for performing the process during which shifts, a time period within which the critical resources must be contacted upon the commencement of the disaster (e.g., 20 minutes), a time period within which the critical resources, must be performing the transferred processes (e.g., 180 minutes), a contact list or emergency call tree for the critical resources, a list of backups for the critical resources, and the like.

As discussed above, according to aspects of the disclosure, the business continuity test administrators evaluate the evidence from the test for each of the parameters in the test assessment and award a score for each of the parameters. According to aspects of the disclosure, the evidence for each of the parameters may have to be submitted by the business to the test administrators within a predetermined time period (e.g., 72 hours) after the business continuity test has been conducted. The evidence may be required to show that an objective for a particular parameter was met. The type of evidence that is required will depend on the particular parameter (and will be discussed in detail below).

According to aspects of this disclosure, some of the parameters relate to planning (i.e., the contingency plan itself) while some of the parameters relate to execution (i.e., the execution of the process when it is implemented according to the contingency plan). According to aspects of the disclosure, the scores for each of the planning parameters may be weighted in order to provide an overall weighted score for planning. For example, the score for each planning parameter may be a predetermined percentage (e.g., 10%) of the overall weighted score for planning. The overall weighted score for planning is designed to provide the business with a simple benchmark to determine if the contingency plan adequately prepares the business for a disaster. According to aspects of the disclosure, the scores for each of the execution parameters may be weighted in order to provide an overall weighted score for execution of the process under the contingency plan (e.g., execution during the business continuity test). For example, the score for each execution parameter may be a predetermined percentage (e.g., 10%) of the overall weighting score for execution of the process under the contingency plan. The overall weighted score for execution of the process under the contingency plan is designed to provide the business with a simple benchmark to determine if the process can be executed adequately during a disaster.

Further, according to aspects of the disclosure, the scores of all the parameters in the test assessment (i.e., both the planning parameter and the execution parameters) may be used to provide a cumulative overall score for the recoverability of process. Hence, the cumulative overall score takes into account both the planning aspects and execution aspects for the recovery of the process. According to some aspects of the disclosure, the cumulative overall score is weighted so that each of the planning aspect and the execution aspect is 50% of the cumulative overall score. The cumulative overall score is designed to provide the business with a simple benchmark to determine if business is adequately prepared for a disaster with regard to that particular process and, thereby, provide assurance to the business on the preparedness of the process to handle a contingency.

Individual parameters in each of the planning and execution aspects will be described below.

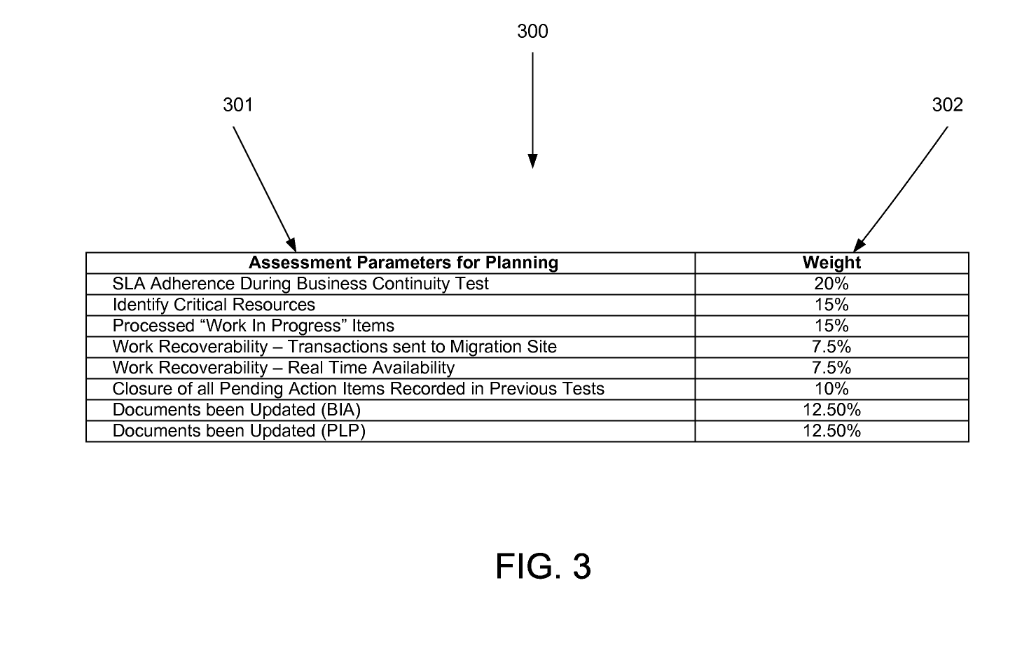

FIG. 3 shows a chart 300 which includes various planning parameters according to an illustrative embodiment of this disclosure. As seen in FIG. 3, column 301 lists the individual planning parameters, while column 302 indicates the respective weight that each of the parameters contributes to the planning score. It is noted that the weights in column 302 are merely examples and according to other embodiments of this disclosure other weights may be used as desired.

As seen in FIG. 3, “Service Level Agreement Adherence during Business Continuity Test” is the first planning parameter identified in column 301. A Service Level Agreement (SLA) may include predefined levels of service that the business will provide during a time at which the business is operating the process as it usually would (i.e., “business as usual” or “BAU”). The SLA may also include predefined levels of service that the business will provide during the disaster. According to aspects of this disclosure, the predefined levels of service that the business will provide during the disaster (or when the process is running under the contingency plan) may be lower than the predefined levels of service that the business provides during “business as usual.” For example, the predefined levels of service for disaster may be 30%, 50%, 70%, 90% of what the predefined levels of service is during business as usual. However, it is noted that the predefined level of service may be the same for both the disaster and “business as usual.” The levels of services may relate to turnaround time to complete a predefined critical work item, the volumes of work items covered/coverage, and the like. This planning parameter may refer to the business plan to ensure service level agreement adherence during the business continuity test.

According to aspects of the disclosure, the planning parameter “Service Level Agreement Adherence during Business Continuity Test” may be scored based on: whether a SLA was identified for critical work items in the contingency plan; whether the SLA was identified in the contingency plan for both a “business as usual” scenario and a disaster scenario (or business continuity test); whether these SLAs were tested during a business continuity test; whether these predetermined and identified SLAs were met during the test; and the like. An example of evidence that may be submitted by the business for this parameter is a spreadsheet of transactions processed by the business during the business continuity test which includes the turnaround time to complete each of the transactions. This will demonstrate whether the turnaround time was within the predefined levels for the SLAs that were stated in the contingency plan. Other evidence may include other spreadsheets which identify whether other levels of the SLAs were met. As seen in column 302, this parameter may be weighted at 20% and, therefore, comprise 20% of the planning score.

As seen in FIG. 3, “Identify Critical Resources” is the second planning parameter identified in column 301. In this parameter, critical resources may refer to business employees who will perform functions necessary to ensure the process is recovered and operable during a disaster and also perform the process while the contingency plan is in effect. This parameter may also include identifying contact information for those employees, which shifts those business employees are scheduled to work, and any backups for those business employees and their respective contact information. It is noted that the critical resources will depend on both only on the particular process and the particular contingency plan.

According to aspects of the disclosure, the planning parameter “Identify Critical Resources” may be scored based on whether the critical resources are identified in the contingency plan; whether they are contactable; whether the critical resources and their contact information are up to date in the contingency plan; whether information for their backups has been identified in the contingency plan; and the like. An example of evidence that may be submitted by the business for this parameter is a list of critical associates and their backups along with a confirmation that each of the critical associates and their backups were invoked for the test and the shifts to which each of the critical associates and their backups were assigned. As seen in column 302, this parameter may be weighted at 15% and, therefore, comprise 15% of the planning score.

As seen in FIG. 3, “Processed ‘Work in Progress’ Items” is the third planning parameter identified in column 301. In this parameter, Work in Progress (WIP) Items refers to work that was in the process of being completed prior to the disaster (or business continuity test). This is different from new work that comes in while the recovered process is functioning under the contingency plan (e.g., new work that comes in to the alternate location while the recovered process functioning). This parameter is directed to whether the business has planned for such WIP items to be recovered and completed (e.g., at the alternate site) during the disaster (or business continuity test) or if such WIP items would be lost or unable to be completed until the original process was restored.

According to aspects of the disclosure, the planning parameter “Processed ‘Work in Progress’ Items” may be scored based on whether the contingency plan accounts for WIP to be transferred to the migrated site, if some or all of the WIP items are able to be completed during the test, and the like. An example of evidence that may be submitted by the business for this parameter is a listing of whether any WIP items were processed during the test, a record of the name of the software tool that retained the WIP item and a screen shot of the application where WIP items are saved and picked up by the alternate site. As seen in column 302, this parameter may be weighted at 15% and, therefore, comprise 15% of the planning score.

As seen in FIG. 3, “Work Recoverability” is the fourth and fifth planning parameter identified in column 301. These parameters relate to business plan for the work from the original site to be recovered and transferred to the migration site (i.e., the alternate site) and worked on during the disaster. The first of these two parameters, “Work Recoverability—Transactions sent to Migration Site” relates to the sheer amount of the items that are recovered and transferred to the migration site. In particular, this parameter measures the percentage of work received at the original site that is likely to be lost during a disaster. The second of these two parameters, “Work Recoverability—Real time Availability” relates to how quickly the items can be recovered and transferred.

According to aspects of the disclosure, the planning parameter “Work Recoverability” may be scored based on the how many work items (e.g., transactions) are lost as compared with the amount of work (e.g., transactions) were received by the alternate site. An example of evidence that may be submitted by the business for the parameter “Work Recoverability—Transactions sent to Migration Site” is a discussion of any transactions that were lost. An example of evidence that may be submitted by the business for the parameter “Work Recoverability—Real time Availability” is a screen shot of the first transaction done after the business continuity test is invoked. This will demonstrate the time taken to resume work at the migration, or alternate, site after the business continuity test has been invoked. As seen in column 302, the above two parameters may be weighted at 7.5% each and, therefore, together comprise 15% of the planning score.

As seen in FIG. 3, “Closure of all Pending Action Items recorded in Previous Tests” is the sixth planning parameter identified in column 301. This planning parameter refers to previous business continuity tests that were already run. Specifically, this planning parameter relates to whether any or all issues that were raised in the evaluation from the previous business continuity test are still open and pending (i.e., have not be addressed) or, alternatively, are closed (i.e., have been addressed).

According to aspects of the disclosure, the planning parameter “Closure of all Pending Action Items recorded in Previous Tests” may be scored based on whether or not 100% of all pending Action Items recorded in previous tests were closed within a specified time frame. An example of evidence that may be submitted by the business for this parameter is a listing of the Action Items recorded in previous tests that have been closed along with the time and date they were closed. As seen in column 302, this parameter may be weighted at 10% and, therefore, comprise 10% of the planning score.

As seen in FIG. 3, “Documents Been Updated” is the seventh and eight planning parameters identified in column 301. These two parameters relate to whether business continuity documents are current. Specifically, the first of these two parameters relates to the issue of whether the Business Analysis Impact BIA is current. The second of these two parameters relates to the issue of whether the contingency plan, or PLP, is current.

According to aspects of this disclosure, the planning parameter “Documents Been Updated” may be scored based on whether the documents have been updated annually or in accordance with another predetermined time period or trigger. An example of evidence that may be submitted by the business for this parameter is an updated BIA and an updated contingency plan. As seen in column 302, these parameters may be weighted at 12.5% each and, therefore, together comprise 25% of the planning score.

It is noted that the eight planning parameters listed in FIG. 3 and discussed above are merely examples and other planning parameters may be used if desired.

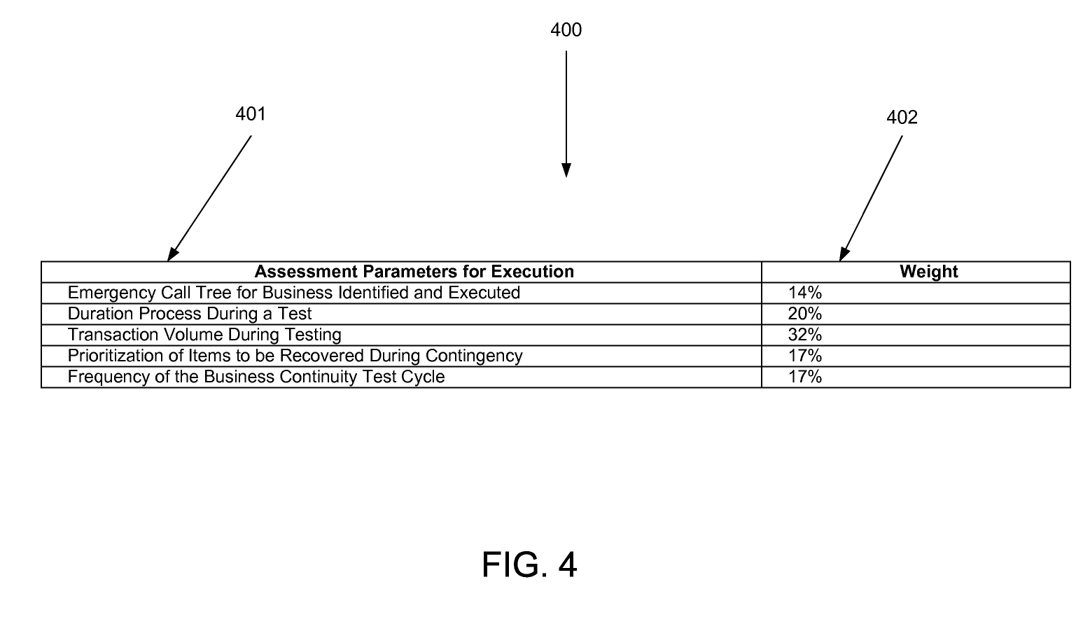

FIG. 4 shows a chart 400 which includes various execution parameters according to an illustrative embodiment of this disclosure. As seen in FIG. 4, column 401 lists the individual parameters, while column 402 indicates the respective weight that each of the parameters contributes to the execution score. It is noted that the weights in column 402 are merely examples and according to other embodiments of this disclosure other weights may be used as desired.

As seen in FIG. 4, “Emergency Call Tree for Business Identified and Executed” is the first execution parameter identified in column 401. According to aspects of this disclosure, an emergency call tree may be a list of business employees to call at the time of a disaster. Hence, this parameter relates to identifying and contacting all the business employees in an emergency call tree.

According to aspects of this disclosure, the execution parameter “Emergency Call Tree for Business Identified and Executed” may be scored based on whether the call tree was identified in the contingency plan, whether the call tree was executed (either partially or completely), whether the contact information in the call tree was current, and the like. An example of evidence that may be submitted by the business for this parameter is an email notification sent to the business employees informing them of the simulated disaster (i.e., the business continuity test) as compared with the list of the call tree listed in the contingency plan. By this comparison the test administrators will be able to determine if all of the associates in the call tree listed in the contingency plan were contacted. As seen in column 402, this parameter may be weighted at 14% and, therefore, comprise 14% of the execution score.

As seen in FIG. 4, “Duration of Process During a Test” is the second execution parameter identified in column 401. According to aspects of this disclosure, during a business continuity test, the process is to be executed for at least one complete shift. The duration of the shift will depend on what type of test is being conducted. For example, if a stress test (e.g., a business continuity test wherein the process is transferred or migrated to other personnel at an alternate location, such as a parent location) is being conducted, then one complete shift may be 8-9 hours of downtime while the parent location takes over during that time period. If a split test is being conducted, then one complete shift may be 4 hours at one of the locations. If a relocation test is being conducted, then one complete shift may be 6 hours of performing production work. This parameter relates to the amount of time the process was executed during the business continuity test.

According to aspects of this disclosure, the execution parameter “Duration of Process During a Test” may be scored based on the amount of time the process was able to be executed during a business continuity test. An example of evidence that may be submitted by the business for this parameter is the invocation email and the revocation email. As seen in column 402, this parameter may be weighted at 20% and, therefore, comprise 20% of the execution score.

As seen in FIG. 4, “Transaction Volume During Testing” is the third execution parameter identified in column 401. According to aspects of this disclosure, this parameter relates to the volume of transactions that were performed at the migration, or alternate, site during the business continuity test as compared with the volume of work that is usually processed at the original site (e.g., daily average of the volume of work).

According to aspects of this disclosure, the execution parameter “Transaction Volume During Testing” may be scored based on whether work items (e.g., critical work items) were identified, if the work items were performed, and, if so, what percentage of the work items were performed (e.g., between 20%-50% of the work items were performed). An example of evidence that may be submitted by the business for this parameter is a spreadsheet from the business regarding the volume of transactions processed at the alternate site during the business continuity test. The test administrators may compare this to an average of the volume of work that is usually processed at the original site. As seen in column 402, this parameter may be weighted at 32% and, therefore, comprise 32% of the execution score.

As seen in FIG. 4, “Prioritization of Items to be Recovered during Contingency” is the fourth execution parameter identified in column 401. According to aspects of this disclosure, the business may prioritize the identified critical work items of the process that should be recovered to ensure business continuity. During a test the business may be required to demonstrate a clear understanding of critical items or tasks. Hence, this parameter relates to the whether these critical items were prioritized and recovered. It is noted that not all items constitute a critical item or task.

According to aspects of this disclosure, the execution parameter “Prioritization of Items to be Recovered during Contingency” may be scored based on whether critical work items were prioritized, if the critical work items were recovered, and, if so, what percentage of the critical work items were recovered (e.g., up to 50% of the critical work items were recovered). An example of evidence that may be submitted by the business for this parameter is a list of activities done or items worked on during the testing showing that they were done according to the priority predefined in the SLA stated in the contingency plan. As seen in column 402, this parameter may be weighted at 17% and, therefore, comprise 17% of the execution score. Of course, a different weighting may be used as desired.

As seen in FIG. 4, “Frequency of Business Continuity Test Cycle” is the fifth execution parameter identified in column 401. According to aspects of this disclosure, the business impact analysis described above may rank the importance to the business of the particular process. The frequency at which the process is to be tested by a business continuity test may be based on this ranking. This parameter relates to whether the process has been tested within the amount of time specified by the importance of the process.

According to aspects of this disclosure, the execution parameter “Frequency of Business Continuity test cycle” may be scored based on whether the business continuity test has been conducted within a predetermined time. An example of evidence that may be submitted by the business for this parameter is a date that the business continuity test was last conducted. As seen in column 402, this parameter may be weighted at 17% and, therefore, comprise 17% of the execution score.

Of course, the above described execution parameters are merely examples. Other parameters may be used as well.

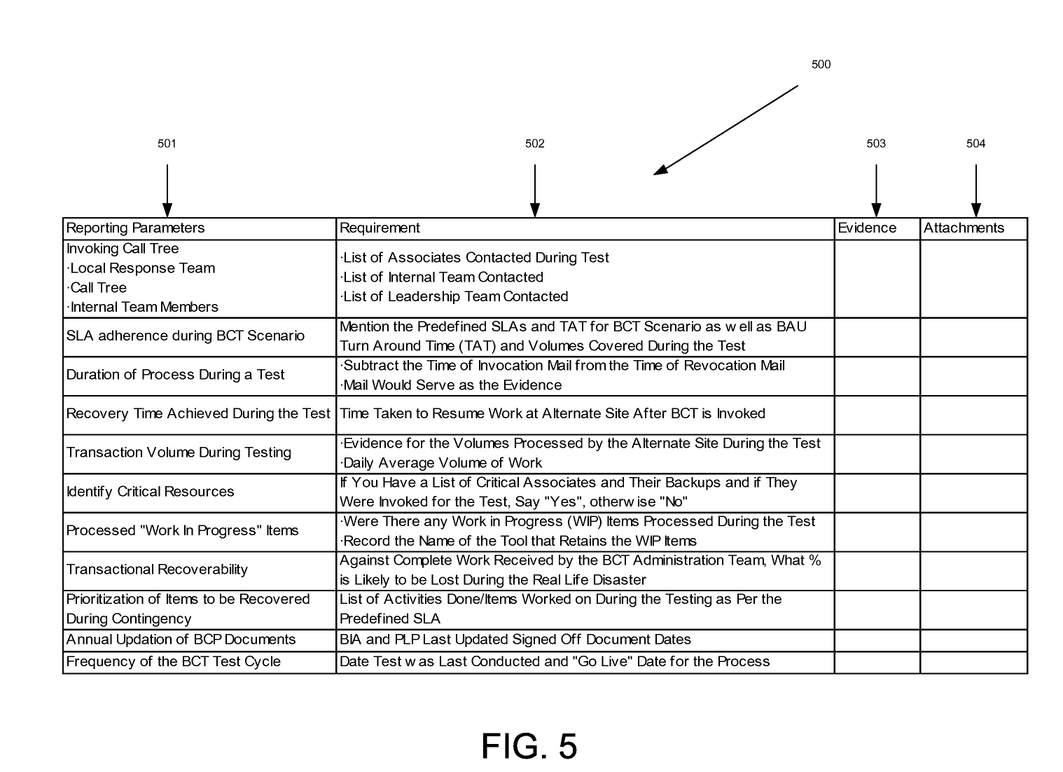

FIG. 5 is an illustrative example of a Test Assessment 500, which was described above. As seen in FIG. 5, a Test Assessment may include various planning and execution parameters that the business continuity test administrators are testing and evaluating in the particular business continuity test. According to aspects of the disclosure, the Test Assessment may be an electronic spreadsheet. According to aspects of the disclosure, evidence regarding the respective parameters listed the test assessment may be attached to the Test Assessment. As seen in FIG. 5, column 501 of the Test Assessment includes a list of the reporting parameters for the particular business continuity test. Column 502 of the Test Assessment may include a list of various requirements that are needed to evaluate the respective reporting parameters. Column 503 of the Test Assessment may include a list of the type of evidence that may be provided by the business in order to evaluate the respective reporting parameters. Column 504 of the Test Assessment may include a place for attachments regarding the evidence to be attached.

As described above, once the business continuity test has been completed, the business may be required to submit evidence for each of the parameters on which the process is being evaluated. For example, according to aspects of this disclosure, once the business continuity test has been completed, the business continuity test administrators may forward a copy of the Test Assessment to the business. The business may then attach evidence for the respective parameters listed in the Test Assessment and send the Test Assessment back to the business continuity test administrators (e.g., the business may have to provide the evidence with a predetermined amount of time, such as 72 hours). Upon receiving the evidence, the business continuity test administrators may use the evidence and/or the contingency plan for the process in order to provide a score for each of the parameters based on the evidence provided by the business.

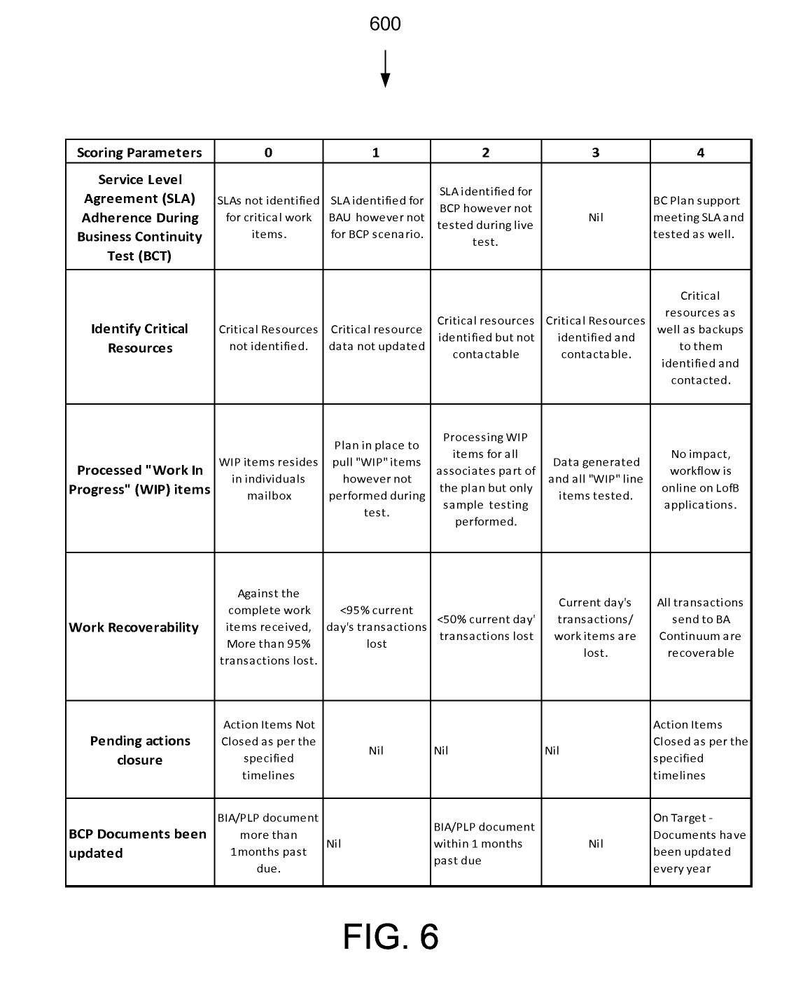

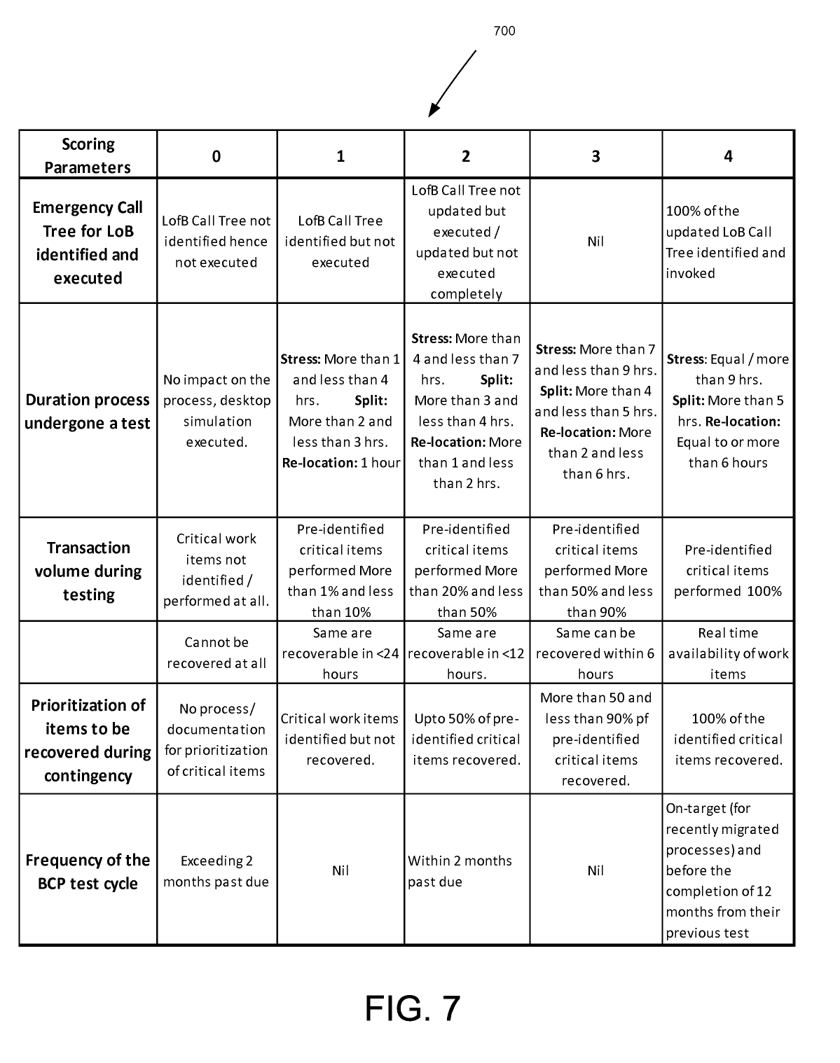

According to aspects of this disclosure, a parameter may be given a score of 0, 1, 2, 3, or 4 by business continuity test administrators. The score that each parameter receives may be based on the evaluation of the evidence provided by the business for that parameter. In order to ensure objectivity and provide a structured approach in defining the requirements of the test, assessing the testing, and providing a standard metric for evaluating the tests, according to aspects of this disclosure, predefined criteria may be associated with each of the different scores, 0-4. FIGS. 6 and 7 are examples of charts which provide illustrative examples of the different criteria associated with the scores of each of the parameters tested and evaluated in a business continuity test.

For example, FIG. 6 is an illustrative example of a report or chart 600 which provides illustrative examples of the different criteria associated with the scores 0, 1, 2, 3, and 4 of each of the planning parameters described above in FIG. 3.

For example, for the planning parameter “SLA Adherence during Business Continuity Test”, the predefined criteria for each score may be as follows: 0=SLAs for critical work items are not identified in the contingency plan; 1=SLAs identified in the contingency plan for “business as usual”, but not for disaster scenario (i.e., a Business Continuity Test); 2=SLAs identified in the contingency plan for a Business Continuity Test, but the SLAs were not tested during the Business Continuity Test, 3=SLAs were identified completely in the contingency plan and SLAs were met during the Business Continuity Test. According to aspects of this disclosure, the predefined criteria to achieve a score of 3 may also achieve a score of 4.

For the planning parameter “Identify Critical Resources”, the predefined criteria for each score may be as follows: 0=No critical resources (i.e., business employees needed to implement the process being run under the contingency plan) are identified in the contingency plan; 1=critical resources are indentified in the contingency plan, but they have not been updated (e.g., business employees who have left the business are included); 2=critical resources are indentified in the contingency plan, but are not able to be contacted (e.g., their contact information is not current); 3=critical resources are indentified in the contingency plan, and are contactable; 4=critical resources are indentified in the contingency plan, and are contactable, further the backups to the critical resources are indentified in the contingency plan, and are contactable.

For the planning parameter “Processes Work in Progress Items”, the predefined criteria for each score may be as follows: 0=Work in Progress items are never pulled from the mailboxes of the individuals from the original site and there is no plan in place to do so; 1=there is a plan in place to pull the Work in Progress items from the mailboxes of the individuals from the original site, but it is not performed during the business continuity test; 2=there is a plan in place to pull the Work in Progress items from the mailboxes of the individuals from the original site, but only part of the some of the Work in Progress items were performed during the business continuity test; 3=Data is generated and all Work in Progress line items are tested (i.e., the process is able to identify and segregate how much work constitutes “work in progress” and all Work in Progress line items are able to be retrieved and brought to closure); 4=No impact, workflow is online on Business application (i.e., all work in progress tasks are available in real time).

For the planning parameter “Work Recoverability”, the predefined criteria for each score may be as follows: 0=more than 95% of the transactions for all the work items received are unrecoverable; 1=more than 95% of the transactions for current day are unrecoverable; 2=more than 50% of the transactions for current day are unrecoverable; 3=the transactions for current day are unrecoverable; 4=all the transactions for all the work items received at the Migration site are recoverable (e.g., all items are received in real time).

For the planning parameter “Pending Actions Closure”, the predefined criteria for each score may be as follows: 0=items identified in the last business continuity test as requiring further action, were not resolved or closed per predetermined timelines; 1=items identified in the last business continuity test as requiring further action, were resolved or closed within predetermined timelines.

For the planning parameter “Documents Been Updated”, the predefined criteria for each score may be as follows: 0=Business Impact Analysis or Contingency Plans have not been updated and are more than 1 month overdue relative to a predetermined deadline set forth by the previous business continuity test; 1=Business Impact Analysis or Contingency Plans have not been updated, but are less than 1 month overdue relative to a predetermined deadline set forth by the previous business continuity test; 2=Business Impact Analysis or Contingency Plans have not been updated but or less than 1 month overdue relative to a predetermined deadline set forth in previous business continuity test (i.e., according to aspects of this disclosure, the predefined criteria to achieve a score of 1 may also be the same for a score of 2); 3=Business Impact Analysis or Contingency Plans are updated or on schedule to be updated relative to a predetermined deadline set forth in previous business continuity test. According to aspects of this disclosure, the predefined criteria to achieve a score of 3 may also achieve a score of 4.

FIG. 7 is an illustrative example of a chart which provides illustrative examples of the different criteria associated with the scores 0, 1, 2, 3, and 4 of each of the execution parameters described above in FIG. 4.

For example, for the execution parameter “Emergency Call Tree for Business Indentified and Executed”, the predefined criteria for each score may be as follows: 0=an emergency call tree is not identified in the contingency plan and, hence, cannot be executed; 1=an emergency call tree is identified in the contingency plan, but not executed; 2=an emergency call tree is identified in the contingency plan and is executed, but the emergency call tree is not updated or an emergency call tree is identified in the contingency plan and is updated, but it is not executed completely; 3=an emergency call tree is identified in the contingency plan, updated and executed completely. According to aspects of this disclosure, the predefined criteria to achieve a score of 3 may also achieve a score of 4.

For the execution parameter “Duration of Process During a Test”, the predefined criteria for each score may be as follows: 0=No impact on the process, desktop simulation executed (i.e., during a test business activities do not cease. Test scenarios and their outcomes are visualized through review and discussion and possible outcomes are recorded); 1=for a Stress Test between 1-4 hours, for a Split Test between 2-3 hours, for a Relocation Test 1 hour; 2=for a Stress Test between 4-7 hours, for a Split Test between 3-4 hours, for a Relocation Test between 1-2 hours; 3=for a Stress Test between 7-9 hours, for a Split Test between 4-5 hours, for a Relocation Test between 2-6 hours; 4=for a Stress Test between 7-9 hours, for a Split Test between 4-5 hours, for a Relocation Test between 2-6 hours.

For the execution parameter “Transaction Volume During Testing”, the predefined criteria for each score may be as follows: 0=critical work items not identified or critical work items not performed at all; 1=critical work items identified, and between 1-10% of critical work items performed; 2=critical work items identified, and between 20-50% of critical work items performed; 3=critical work items identified, and between 50-90% of critical work items performed; 4=critical work items identified, and more than 100% of critical work items performed.

For the execution parameter “Prioritization of Items to be Recovered during Contingency”, the predefined criteria for each score may be as follows: 0=No process or documentation for prioritizing critical work items; 1=critical work items identified but not recovered; 2=critical work items identified and up to 50% of the critical work items are recovered; 3=critical work items identified and between 50-90% of the critical work items are recovered; 4=critical work items identified and more than 90% of the critical work items are recovered.

For the execution parameter “Frequency of Business Continuity Test Cycle”, the predefined criteria for each score may be as follows: 0=the deadline for conducting a business continuity test is over 2 months past due; 1=the deadline for conducting a business continuity test is overdue but less than 2 months past due; 3=a business continuity test is scheduled to be conducted on or before the deadline based off the date the previous business continuity test was conducted.

The above listed examples of the different criteria associated with the scores of each of the parameters tested and evaluated in a business continuity test are merely illustrative and other criteria could be used as desired.

As discussed above, according to aspects of this disclosure, each parameter is evaluated by the business continuity test administrators and given a score ranging from 0-4 based on the evidence and/or contingency plan and the predefined criteria. Once the scores are generated they may be included in a scorecard.

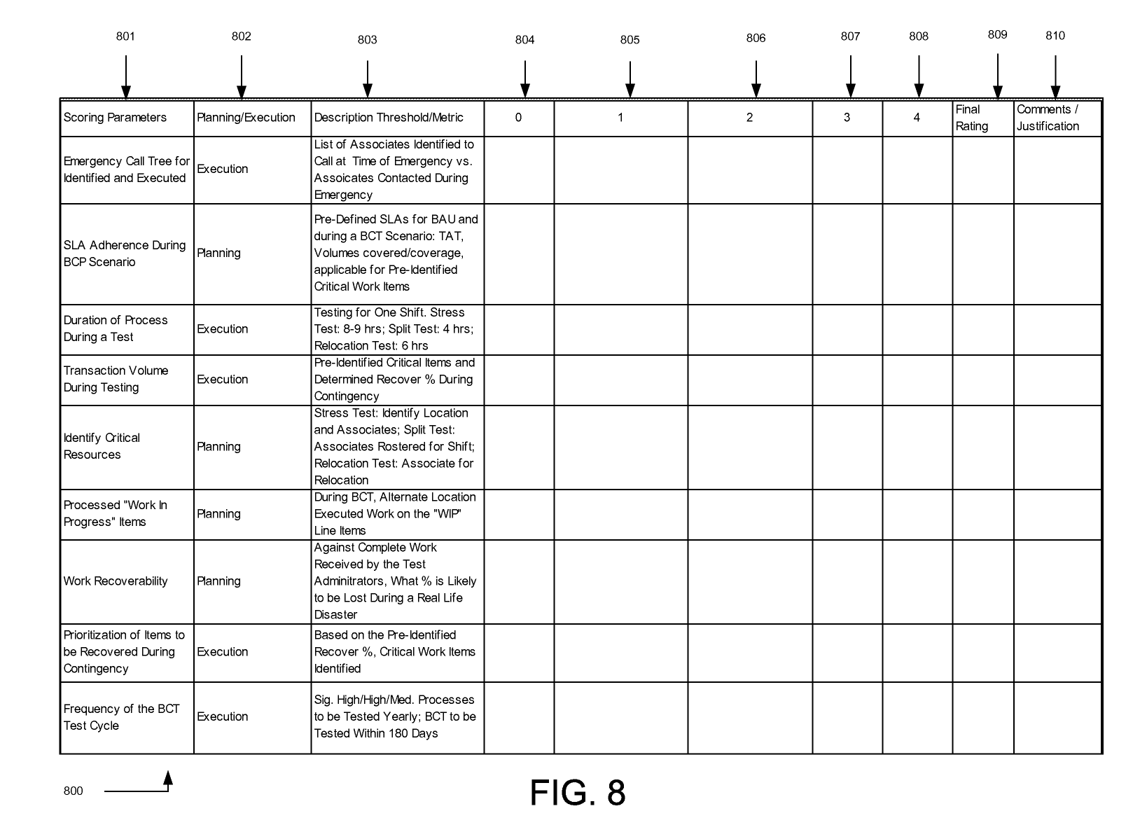

FIG. 8 is an illustrative example of such a scorecard 800. As seen in FIG. 8, the scorecard may include a column 801 which lists the particular parameters tested and evaluated in the business continuity test. The scorecard may also include a column 802 which lists whether the respective parameter is either a planning parameter or an execution parameter. The scorecard may also include a column 803 which lists a description threshold/metric for the respective parameter. The scorecard may also include columns 804-808 which list predetermined criteria (e.g., such as discussed in the charts shown in FIGS. 6 and 7) associated with the respective score for that particular parameter. The scorecard may also include a column 809 which lists the actual score the parameter received from the business continuity test administrators. The scorecard may also include a column 810 which lists comments or a justification by the business continuity test administrators for why the respective parameter received such a score. The scorecard 800 is convenient way for a business to quickly and simply determine the recoverability of a particular business process.

As described above, according to aspects of the disclosure, each of the parameters is weighted to contribute a portion of an overall score for either planning or execution. For example, FIG. 3 gives an illustrative example of the weighting for each parameter related to planning. Therefore, according to aspects of the disclosure, when a score (e.g., 0-4) is assigned to a planning parameter, the score is multiplied by the percentage for that planning parameter to produce a weighted score for that planning parameter. According to aspects of the disclosure, once the weighted scores for each of the planning parameters has been calculated, the weighted scores for all of the planning parameters are added to determine an overall weighted score for planning. As discussed above, the overall weighted score for planning is designed to provide the business with a simple benchmark to determine if the contingency plan adequately prepares the business for a disaster.

Similarly, FIG. 4 gives an illustrative example of the weighting for each parameter related to execution. Therefore, according to aspects of the disclosure, when a score (e.g., 0-4) is assigned to an execution parameter, the score is multiplied by the percentage for that execution parameter to produce a weighted score for that execution parameter. According to aspects of the disclosure, once the weighted scores for each of the execution parameters has been calculated, the weighted scores for all of the execution parameters are added to determine an overall weighted score for execution. As discussed above, the overall weighted score for execution of the process under the contingency plan is designed to provide the business with a simple benchmark to determine if the process can be executed adequately during a disaster.

According to aspects of the disclosure, overall weighted score for planning and the overall weighted score for execution may be averaged to determine a cumulative overall score for the recoverability of the process. In other words, each of the overall weighted score for planning and the overall weighted score for execution is weighted at 50% of the cumulative overall score. Hence, the cumulative overall score takes into account both the planning aspects and execution aspects of the recovery of the process and the continuity of business. As discussed above, the cumulative overall score is designed to provide the business with a simple benchmark to determine if business is adequately prepared for a disaster with regard to that particular process and, thereby, provide assurance to the business on the preparedness of the process to handle a contingency.

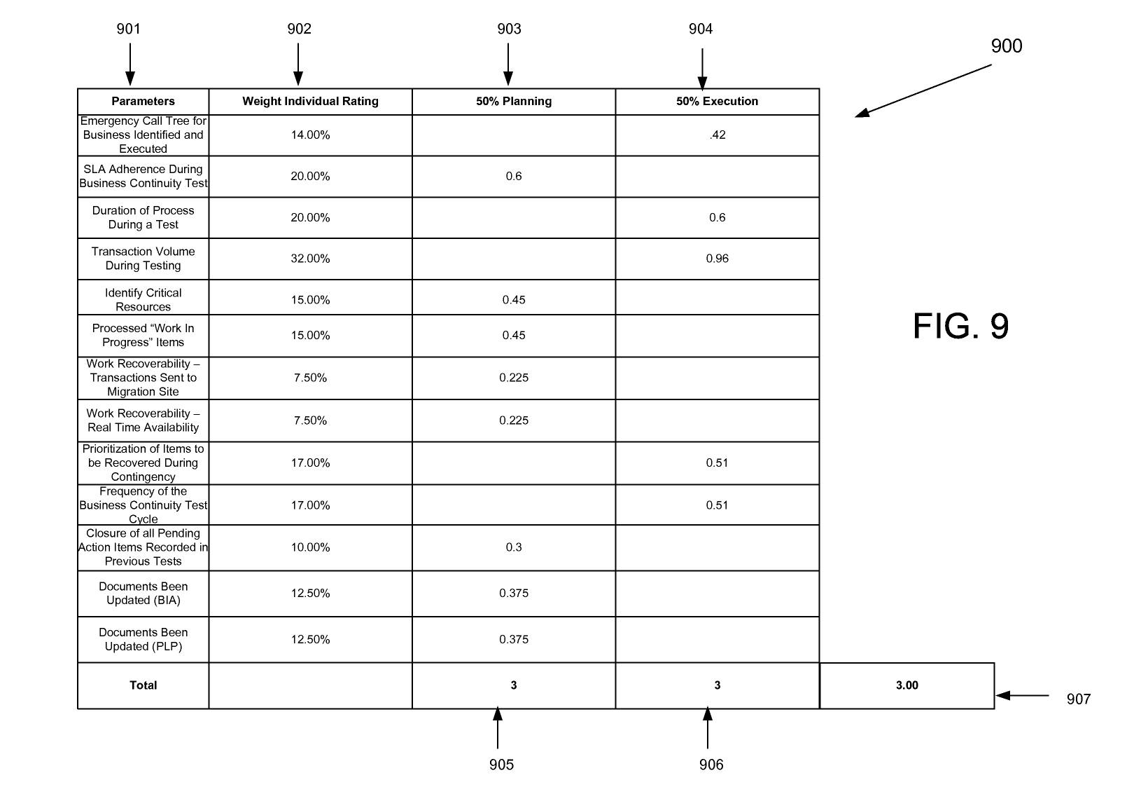

FIG. 9 is an illustrative example of a weighted score grid 900 according to aspects of the disclosure. As seen in FIG. 9, the weighted score grid may include a column 901 which lists the parameters used in a business continuity test. Further, the weighted score grid may include a column 902 which lists the individual weighting of each parameter. Further, the weighted score grid may include columns 903 and 904 which list the respective calculated individual weighting of each parameter. As seen in FIG. 9, a section 905 of the weighted score grid 900 discloses the calculated total of the overall weighted score for planning. As seen in FIG. 9, a section 906 of the weighted score grid 900 discloses the calculated total of the overall weighted score for execution of the process. As seen in FIG. 9, a section 907 of the weighted score grid 900 discloses the calculated total of the cumulative overall score. For illustrative purposes, in the example shown in FIG. 9, the score for each of the parameters has been set a 3. Hence, it is easily understood, that each of the calculated totals for the overall weighted score for planning, the overall weighted score for execution of the process, and the cumulative overall score will all be 3.

According to aspects of the disclosure, the testing and evaluation system may include a final rating chart for indicating the overall level of assurance that the business may reasonably have in the recoverability and resiliency of the process. According to aspects of the disclosure, the final rating chart may include a series of numerical ranges which are organized into a series of different categories. For example, the categories in the final rating chart may include a category for strong assurance, a category for good assurance, a category for fair assurance, a category for weak assurance. Additionally, according to aspects of the disclosure, the numerical ranges in the final rating chart may range from 0.1-4.0 and include ranges in between these extremes. The different ranges will correlate to the different categories. Further, according to aspects of the disclosure, the final rating chart may also be organized according to the Business Impact Analysis rating of the processes to be evaluated. For example, the final rating chart may be organized according to the Business Impact Analysis ratings: Significantly High, High, Medium and Low. The cumulative overall score calculated as described above may be compared with the ranges in the final rating chart to determine into which category the cumulative overall score of the process belongs and, hence, indicates what level of assurance that the business may reasonably have in the overall recoverability and resiliency of the process.

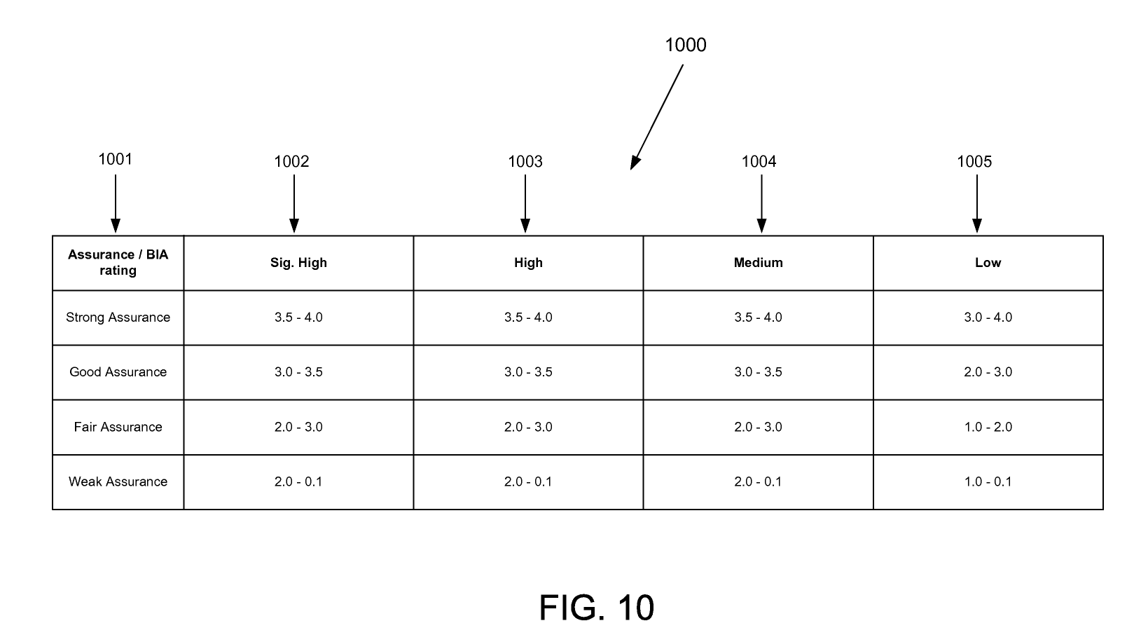

FIG. 10 is an illustrative example of a final rating chart 1000 according to aspects of this disclosure. As seen in FIG. 10, a first column 1001 lists the levels of assurance in rows: strong assurance, good assurance, fair assurance, weak assurance, respectively. Further, columns 1002, 1003, 1004 and 1005 list the Business Impact Analysis ratings, Significantly High, High, Medium and Low respectively. The grid formed by the rows and columns are populated with numerical ranges. The numerical ranges will indicate the cumulative overall score that must be achieved by the process during the business continuity test in order to provide the respective level of assurance.

As seen in FIG. 10, according to aspects of this disclosure, two different processes may achieve the same score, but depending on their respective business analysis ratings, be assigned different levels of assurance according to the final rating chart. For example, according to aspects of this disclosure, a process that is rated as significantly high and achieves a score of 2.9 would be rated as fair assurance, while a process that is rated as low and achieves the same score of 2.9 would be rated as good assurance. The rationale behind the scoring system for final rating chart is that if a process is rated as significantly high, then the process is more important to the business than a process that is rated lower. Therefore, the process rated as significantly high may be held to a higher standard, because the business would have want to be more certain or assured of the overall recoverability and resiliency of the process.

It is noted that the system for determining and calculating the recoverability and resiliency of process may be an electronically based system, such as a web-based application. For example, the system may include a computer (such as described above), a network of computers, software that configures a computer to perform the above described features, and the like. The data, such as the evidence provided by the business, may be electronically received by the business continuity testing and evaluation system. Further, the business continuity test administrators may electronically transmit their evaluations to the business continuity testing and evaluation system. Additionally, the business continuity test administrators may use the electronically based business continuity testing and evaluation system to electronically enter their evaluations, perform calculations such as the weighted calculations of the planning and execution parameters in order to provide the overall planning score, the overall execution score and the cumulative overall score of the process. It is noted that according to aspects of the disclosure, the electronically based business continuity testing and evaluation system may include one or more algorithms which include a set of predetermined rules to be applied to the data (e.g., to calculate a cumulative overall score) to perform such calculations automatically. In other words, the electronically based business continuity testing and evaluation system may perform calculations and provide the scorecard and ratings automatically once the evidence and evaluations data has been electronically received.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present disclosure. The description is thus to be regarded as illustrative instead of restrictive on the present disclosure.

1. A computer-assisted method for determining a recoverability of a process comprising:
electronically receiving a first data, by a computer, relating to a contingency plan for recovering a process;
electronically receiving a second data, by the computer, relating to an organization's execution of the contingency plan during a test of the recoverability of the process;
calculating a cumulative overall score for the recoverability of the process; and
comparing the cumulative overall score with a rating chart stored in the computer, the rating chart including numerical ranges defining a level of assurance of the recoverability of the process,
wherein calculating the cumulative overall score includes using the electronically received first data relating to the contingency plan to determine a first overall weighted score for each of a first predetermined set of parameters related to the contingency plan,
wherein calculating the cumulative overall score includes using the electronically received second data relating to the organization's execution of the contingency plan to determine a second overall weighted score for each of a second predetermined set of parameters related to the organization's execution of the contingency plan,
wherein the computer is configured to apply a set of predetermined rules to the first and the second overall weighted scores for each of the first and the second predetermined sets of parameters in order to calculate the cumulative overall score,
wherein the first and the second overall weighted scores are computed by:
multiplying a predetermined percentage to each score associated with the first and the second predetermined sets of parameters to yield one or more weighted scores corresponding to each of the first and the second predetermined sets of parameters,
adding the one or more weighted scores associated with the first predetermined set of parameters to yield the first overall weighted score corresponding to the first predetermined set of parameters, and
adding the one or more weighted scores associated with the second predetermined set of parameters to yield the second overall weighted score corresponding to the second predetermined set of parameters, and
wherein the predetermined rules are stored in the computer.

2. The computer-assisted method according to claim 1, wherein the predetermined rules for calculating the cumulative overall score include calculating a weighted average of the first overall weighted score and the second overall weighted score.

3. The computer-assisted method according to claim 2, wherein a weight associated with the calculation of the weighted average for each of the first overall weighted score and the second overall weighted score is equal to fifty percent.

4. The computer assisted method according to claim 1, wherein the predetermined rules for calculating the cumulative overall score includes computing the average of the first overall weighted score and the second overall weighted score.

5. The computer assisted method according to claim 1, wherein the parameters related to the contingency plan include at least one of: planning for adherence to service level agreement of the contingency plan during the execution of the organization's performance of the process according to the contingency plan, identification of critical resources, planning for work in progress items to be able to be processed during the execution of the organization's performance of the process according to the contingency plan, planning for transactions to be able to be sent to an alternate site during the execution of the organization's performance of the process according to the contingency plan, planning to minimize the length of time for the transactions to become available at the alternate site during the execution of the organization's performance of the process according to the contingency plan, whether any pending items noted during a previous evaluation have been closed, whether the contingency plan has been updated within a predetermined amount of time.

6. The computer assisted method according to claim 1, wherein the parameters related to the organization's execution of the contingency plan include at least one of: whether a predefined list of associates of the organization and their contact information has been defined in the contingency plan and the associates of the organization were contacted during the execution of the organization's performance of the process according to the contingency plan, the duration of the execution of the organization's performance of the process according to the contingency plan during a test of the recoverability of the process, whether transactions performed by the process were recovered according to a priority defined in the contingency plan, whether the recoverability of the process has been tested within a predetermined time relative to the most recent test of the recoverability of the process.

7. The computer assisted method according to claim 1, wherein the test of the recoverability of the process includes transferring the process to a migration site which is different from an original site wherein the process is usually performed and performing the process at the migration site.

8. The computer assisted method according to claim 1, wherein the rating chart includes different sets of numerical ranges, wherein the different sets of numerical ranges are based on the level of importance of a process to the organization.

9. A computer comprising:
a processor configured to execute computer-executable instructions; and
a memory for storing the computer executable instructions that, when executed by the processor, cause the computer to perform a method for determining the recoverability of a process, the method comprising:
receiving a first data relating to a contingency plan for recovering the process;
receiving a second data relating to an organization's execution of the contingency plan during a test of the recoverability of the process;
calculating a cumulative overall score for the recoverability of the process; and
comparing the cumulative overall score with a rating chart stored in the computer, the rating chart including numerical ranges defining a level of assurance of the recoverability of the process, and
wherein calculating the cumulative overall score includes using the electronically received first data relating to the contingency plan to determine a first overall weighted score for each of a first predetermined set of parameters related to the contingency plan,
wherein calculating the cumulative overall score includes using the electronically received second data relating to the organization's execution of the contingency plan to determine a second overall weighted score for each of a second predetermined set of parameters related to the organization's execution of the contingency plan,
wherein the computer is configured to apply a set of predetermined rules to the first and the second overall scores for each of the first and the second predetermined sets of parameters in order to calculate the cumulative overall score,
wherein the first and the second overall weighted scores are computed by:
multiplying a predetermined percentage to each score associated with the first and the second predetermined sets of parameters to yield one or more weighted scores corresponding to each of the first and the second predetermined sets of parameters,
adding the one or more weighted scores associated with the first predetermined set of parameters to yield the first overall weighted score corresponding to the first predetermined set of parameters, and
adding the one or more weighted scores associated with the second predetermined set of parameters to yield the second overall weighted score corresponding to the second predetermined set of parameters, and
wherein the rules are stored in the computer.

10. The computer according to claim 9, wherein the computer is configured to calculate a weighted average of the first overall weighted score and the second overall weighted score.

11. The computer according to claim 10, wherein the weight associated with the calculation of the weighted average for each of the first overall weighted score and the second overall weighted score is equal to fifty percent.

12. The computer according to claim 9, wherein the predetermined rules for calculating the cumulative overall score includes computing the average of the first overall weighted score and the second overall weighted score.

13. The computer according to claim 9, wherein the parameters related to the contingency plan include at least one of: planning for adherence to service level agreement of the contingency plan during the execution of the organization's performance of the process according to the contingency plan, identification of critical resources, planning for work in progress items to be able to be processed during the execution of the organization's performance of the process according to the contingency plan, planning for transactions to be able to be sent to an alternate site during the execution of the organization's performance of the process according to the contingency plan, planning to minimize the length of time for the transactions to become available at the alternate site during the execution of the organization's performance of the process according to the contingency plan, whether any pending items noted during a previous evaluation have been closed, whether the contingency plan has been updated within a predetermined amount of time.

14. The computer according to claim 9, wherein the parameters related to the organization's execution of the contingency plan include at least one of: whether a predefined list of associates of the organization and their contact information has been defined in the contingency plan and the associates of the organization were contacted during the execution of the organization's performance of the process according to the contingency plan, the duration of the execution of the organization's performance of the process according to the contingency plan during a test of the recoverability of the process, whether transactions performed by the process were recovered according to a priority defined in the contingency plan, whether the recoverability of the process has been tested within a predetermined time relative to the most recent test of the recoverability of the process.

15. The computer according to claim 9, wherein the rating chart includes different sets of numerical ranges, wherein the different sets of numerical ranges are based on the level of importance of a process to the organization.

16. A computer comprising:
a processor configured to execute computer-executable instructions; and
a memory for storing the computer-executable instructions that, when executed by the processor, cause the computer to perform a method for determining the recoverability of a process, the method comprising:
receiving a first data relating to a contingency plan for recovering the process;
receiving a second data relating to an organization's execution of the contingency plan during a test of the recoverability of the process;
calculating a cumulative overall score for the recoverability of the process;
comparing the cumulative overall score with a rating chart stored in the computer, the rating chart including numerical ranges defining a level of assurance of the recoverability of the process; and
wherein calculating the cumulative overall score includes using the electronically received first data relating to the contingency plan to determine a first overall weighted score for each of a first predetermined set of parameters related to the recoverability of the process,
wherein calculating the cumulative overall score includes using the electronically received second data relating to the organization's execution of the contingency plan to determine a second overall weighted score for each of a second predetermined set of parameters related to the organization's execution of the contingency plan,
wherein the computer is configured to apply a set of predetermined rules to the first and the second overall scores for each of the first and the second predetermined sets of parameters in order to calculate the cumulative overall score,
wherein the first and the second overall weighted scores are computed by:
multiplying a predetermined percentage to each score associated with the first and the second predetermined sets of parameters to yield one or more weighted scores corresponding to each of the first and the second predetermined sets of parameters,
adding the one or more weighted scores associated with the first predetermined set of parameters to yield the first overall weighted score corresponding to the first predetermined set of parameters, and
adding the one or more weighted scores associated with the second predetermined set of parameters to yield the second overall weighted score corresponding to the second predetermined set of parameters, and
wherein the rules are stored in the computer.

17. The computer according to claim 16, wherein the predetermined rules for calculating the cumulative overall score include averaging the first overall weighted score related to the contingency plan with the second overall weighted score related to the organization's execution of the contingency plan.

18. The computer according to claim 17, wherein the predetermined rules for calculating the cumulative overall score includes calculating a weighted average of the first overall weighted score and the second overall weighted score.
